(19) United States
(12) Patent Application Publication
(10) Pub. No.: US 2010/0055239 A1
(43) Pub. Date: Mar. 4, 2010

(54) EVAPORATOR OF VINASSE CONCENTRATION FOR DISTILLERIES IN GENERAL

(75) Inventors: JAIME LACERDA De ALMEIDA, Valinhos (BR); PAULO HENRIQUE SAMPAIO, Araraquara (BR)

Correspondence Address: MCKEE, VOORHEES & SEASE, P.L.C., 801 GRAND AVENUE, SUITE 3200, DES MOINES, IA, 50309-2721, US

(73) Assignees: Jaime Lacerda De Almeida, Valinhos (BR); Citrotec Industria E Ltda., Araraquara (BR)

(21) Appl. No.: 12/204,504

(22) Filed: Sep. 4, 2008

(51) Int. Cl. C12C 7/28

(52) U.S. Cl. 426/31

(57) ABSTRACT

“EVAPORATOR OF VINASSE CONCENTRATION FOR DISTILLERIES IN GENERAL”, it is applied preferentially in the distillery (1) of ethanol, whose constituent equipments allow the accomplishment of vinasse concentration process (2) using caisson (T1) of evaporation as “reboiler” of the columns (C1 and C2), as well as caisson (T2) of evaporation as condenser of the mentioned columns (C1 and C2), without extra consumption of energy or vapor (3) and water (4), for that using bombs (5) for movement of the product; pre-heaters (not represented) for the heating of the wine (6); final heater (not represented) which accomplishes the last heating of the wine; column (C1) responsible for the first distillation; caissons (T) which execute the evaporation of vinasse; separators (S) that dissociate the vapors of the liquids in the evaporator; column (C2) responsible for the second distillation; evaporative condenser (7) that condenses the vapors of the last effects and system of air removal (8) of equipment by means of vacuous.

### BRIEF INTRODUCTION

The present Patent of Invention request refers to a new EVAPORATOR OF VINASSE CONCENTRATION FOR DISTILLERIES IN GENERAL, especially of a distillery preferentially of alcohol coupled to an evaporator of multiple effects and stages that makes possible the use of the condensation energy to accomplish the vinasse concentration, using the principle of descending turbulent fog, bringing a series of technical advantages as, for instance, low consumption of water and external energy, great productivity among other advantages to be described along this report.

### BRIEF BACKGROUND

Since the beginning of the production of alcohol, the vinasse is one of the residues of the productive process that more worries the technicians and society in general, due to its pollutant potential associated to the great amount generated in the process. Consequently, for several years vinasse was seen as the great cause of damages to the environment, however with the evolution of the sugar-ethanol technology the vinasse should be seen now as a profitable sub-product of the productive chain in subject and, no more as a residue to be discarded.

It can be said that the vinasse is one of the responsible for the production cost highly competitive of the national sugar cane related to other countries, due to the fact that the vinasse properly collected made of the cane the only self-sufficient agricultural product in manuring of the soil, almost substituting in the totality the use of chemical fertilizers.

The cost of fertirrigation more and more reduced by new technologies and means of transportation make possible to vinasse be broadly applied in to farming.

With the world increment of the demand for alcohol combustible and with the constant preoccupation with the environment, it was brought to the light the need of new researches and technology development to enable or make possible the concentration of vinasse, besides use options of use besides fertirrigation of the soil.

### State of Technique

Actually, the conventional distilleries are basically formed by distillation columns, in the first column the wine (≈9° GL), with help of external vapor and water origins flagma (≈15° GL), following to second distillation column. In the first column it is collected also vinasse with about 97% of water (3° Brix). In the second column the flagma, with help of external vapor and water is transformed in alcohol (≈93° GL), being as residue in this column the flagmass.

With the process and equipment to produce ethanol known of technique, has as sub-product the vinasse in the ratio of 12˜13 1 for each liter of produced ethanol, it means that for each hundred thousand liters of alcohol it was obtained a million three hundred thousand liters of vinasse.

The vinasse obtained by equipment and process has as basic particularities high tenor of salts, mainly potassium (K), great biological demand of oxygen (DBO) ˜7.000 mg/l and chemical demand of oxygen (DQO) ˜24.000 mg/l and very low brix (percentage of soluble solids ˜3%), particularities that define the utilization of vinasse for other ends other than for fertirrigation.

On the other hand, almost all vinasse to be used in the farming is moved by means of trucks, which generates great environmental pollution and degradation of the highways.

### Of the New Evaporator

Thinking of the above inconvenients, the inventor developed the evaporator of vinasse concentration that consists of junction of the evaporator properly said with distillators, making with that evaporators act as condensers of distillation columns, taking advantage of the energy to concentrate the vinasse.

One of the highlight points of the invention is to proceed the vinasse concentration process using evaporation bodies as “reboiler” of the columns and condensers of distillators, without extra consumption of energy.

In short, the present invention introduces as more preponderant advantages:
Ethanol production without external water or cooling towers consumption, due to equipment use a condenser of a evaporative kind;
Ethanol production with vinasse low formation, without increment in the vapor consumption—about 20× less vinasse (0,6 1 for each liter of ethanol) with up to 60 brix of concentration;
Reduction of the volume of vinasse around 95%, carrying in 95% less movement and 95% less storage area;
With vinasse concentration, it obtains as byproduct the condensate (water) with DBO close to 100 mg/l and DQO of about 300 mg/l.
It constitutes an economic, ecological and effective option in the destination of vinasse;
Due to alteration of flow away of columns rate, it is possible to obtain twice the production for the same column diameter;
Easy adaptability to the existed columns.

To follow, the invention will be explained technically, using as base the drawings related below, in an illustrative and not limited way:

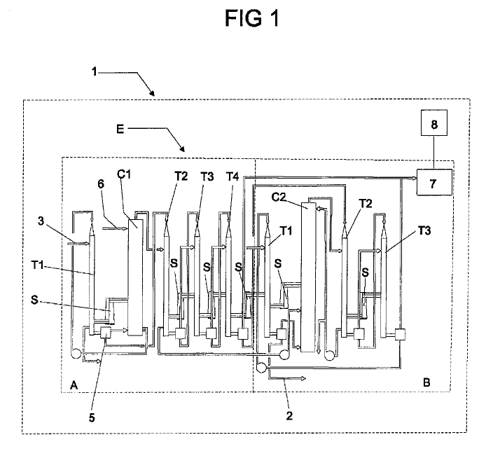

FIG. 1: Schematic view of evaporator of vinasse concentration for distilleries in general;

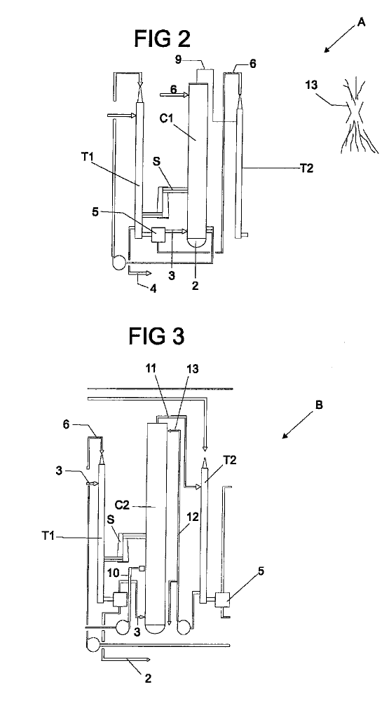

FIG. 2: Detail of the column A of evaporator of vinasse concentration for distilleries in general;

FIG. 3: Detail of the column B of evaporator of vinasse concentration for distilleries in general.

### DETAILED DESCRIPTION

The EVAPORATOR OF VINASSE CONCENTRATION FOR DISTILLERIES IN GENERAL, object of this Invention Patent solicitation is applied preferentially to ethanol distillery (1), whose constituent equipments allow the accomplishment of vinasse concentration process (2), using evaporation caisson (T1) as “reboiler” of the columns (C1 and C2), as well as evaporation caisson (T2) as condenser of the said columns (C1 and C2), without extra consumption of energy or vapor (3) and water (4), for so much using bombs (5) for movement of the product; pre-heaters (not represented) for the heating of the wine (6); final heating (not represented) which accomplishes the last heating of the wine (6); column (C1) responsible for the first distillation; caissons (T) which execute the evaporation of vinasse; separators (S) which dissociate the vapors of the liquids in the evaporator; column (C2) responsible for the second distillation; evaporative condenser (7) that condenses the vapors of the last effects and system of air removal (8) of the equipment by means of vacuum.

Of a more defined way, the evaporator (E) of vinasse concentration (2) receives the wine (6) originated from the broth fermentation, after centrifugation, it is led to the pre-heaters (not represented) which receive energy of the vapors (3) generated of the evaporation of caissons elevating the temperature of the wine (6) which follows to the final heater (not represented) for then enter in the first column (C1) of distillation already in the ideal temperature. In this column (C1), the wine (6) is distillate, for that said column (C1) receives vapor (3) of caisson (T1) from 1^{st} effect that nothing more is than the evaporation body of a “reboiler” kind, originating as products at the bottom the vinasse (2) and at the top flagma or alcoholic vapor (9). Each caisson is accompanied of a separator (S) that dissociates the vapor of the liquid. Being like this, the evaporation has beginning with the vinasse (2) originated from the first column (C1) of distillation pumped (5) to the caisson (T1) of 1^{st} effect where has beginning its concentration, being pumped (5) to the caisson (T2) second effect or evaporation body of a condenser kind, to the caisson (T3) of 3^{rd} effect, caisson (T4) of 4^{th} effect and so forth until a number of caissons enough to attend the needs of user, so that in the last caisson it has the vinasse (2) concentrated on up to 60 times of the normal concentration of a conventional distillery. The alcoholic vapor or flagma (9) produced in the first column (C1) of distillation is condensate in the hull of caisson (T2) of 2^{nd} effect that provides energy for other effects of vinasse concentrator.

After condensation (˜45° GL) it is pumped for the second column (C2) of distillation, and the distillated flagma (10) produces alcoholic vapor (11) and the residue flagmass (12). Of this way, the column (C2) receives energy from caisson (T1) of 1^{st} effect of the part (B) of the evaporator just as in the part (A). In cases with vinasse smaller concentration (2), the energy is injected directly in the column (C2). The alcoholic vapor (11) produced in the second column (C2) of distillation is equally condensate in the second caisson (T2), providing energy or vapor (3) for the other effects of part (B) of vinasse concentrator. After condensation, the alcohol (12) is removed by means of bomb (5) where is accomplished the flow away control (13) to the second column (C2) and a part is retreat as final product alcohol (12′) 93.2 INPM.

The vapors (3) of the last effects of part (A) and part (B) of the evaporator are condensed in an evaporative condenser (7) that receives the vapors in a tubular bunch (not demonstrated) wet externally by a spray of condensate re-circulated by bomb (not demonstrated) and cooled by exhauster (not demonstrated), in order to promote the condensation of the vapors and the remained air is directed to the removal system (8) of air.

The caissons of this patent request use a “venturi” (13) in the superior extreme portion, which promotes the formation of a turbulent fog (14) that by the pressure differential propitiates spray formation. Thus, the fog accelerated thermally to high speeds causes a flow with high turbulence, what complicates the formation of encrustations in the walls of caissons.

What is claimed is:

1) “EVAPORATOR OF VINASSE CONCENTRATION FOR DISTILLERIES IN GENERAL” receives the wine (6) originated from the fermentation of the broth led to the pre-heaters (not represented) wherein receives energy of the vapors (3) generated from the evaporation of caissons, elevating the temperature of the wine (6) which follows to the final heater (not represented) for then enter in the first column (C1) where is distillate, for that said column (C1) receives vapor (3) of caisson (T1) of 1^{st} effect that nothing more is than the evaporation body of a “reboiler” kind, originating as products at the bottom vinasse (2) and at the top flagma or alcoholic vapor (9); each caisson is accompanied of a separator (S); the evaporation has beginning with vinasse (2) originated from the first column (C1) of distillation (5) pumped to the caisson (T1) of 1^{st} effect where has beginning its concentration, being pumped (5) to the caisson (T2) of second effect or evaporation body of a condenser kind, to caisson (T3) of 3^{rd} effect, caisson (T4) of 4^{th} effect and so forth until a number of caissons enough to attend the needs of user, so that in the last caisson it has the concentrated vinasse (2); the alcoholic vapor or flagma (9) produced in the first column (C1) of distillation is condensate in the hull of caisson (T2) of 2^{nd} effect that supplies energy to the other effects of vinasse concentrator; after condensate (˜45° GL) it is pumped to the second column (C2) of distillation and distillated flagma (10) produces alcoholic vapor (11) and the flagmass residue (12); the column (C2) receives energy of caisson (T1) of 1^{st} effect of part (B) of the evaporator just as in the part (A).

2) “EVAPORATOR OF VINASSE CONCENTRATION FOR DISTILLERIES IN GENERAL”, according to claim 1, wherein in cases with vinasse smaller concentration (2), the energy is injected directly in the column (C2).

3) “EVAPORATOR OF VINASSE CONCENTRATION FOR DISTILLERIES IN GENERAL” according to claim 1, wherein the alcoholic vapor (11) produced in the second column (C2) of distillation is equally condensate in the second caisson (T2), providing energy or vapor (3) to the other effects of the part (B) of vinasse concentrator; after condensate, the alcohol (12) is removed by means of bomb (5) where is accomplished the flow away control (13) to the second column (C2) and part is retreat as final product alcohol (12′) 93.2 INPM.

4) “EVAPORATOR OF VINASSE CONCENTRATION FOR DISTILLERIES IN GENERAL” according to claim 1, wherein the vapors (3) of the last effects of the part (A) and part (B) of the evaporator are condensed in an evaporative condenser (7) that receives the vapors in a tubular bunch (not demonstrated) wet externally by a spray of condensate re-circulated by bomb (not demonstrated) and cooled by exhauster (not demonstrated), in order to promote the condensation of the vapors and the remained air is directed to the removal system (8) of air.

5) “EVAPORATOR OF VINASSE CONCENTRATION FOR DISTILLERIES IN GENERAL” according to claim 1, wherein the caissons use a “venturi” (13) in the superior extreme portion, which promotes the formation of a turbulent fog (14).
